(19) United States
(12) Patent Application Publication
(10) Pub. No.: US 2008/0013759 A1
(43) Pub. Date: Jan. 17, 2008

(54) IMPEDANCE SELECTION CIRCUIT

(76) Inventor: Derrick L. Baird, Knoxville, TN (US)

Correspondence Address: WITHERS & KEYS, LLC, P. O. BOX 71355, MARIETTA, GA, 30007-1355, US

(21) Appl. No.: 11/456,650

(22) Filed: Jul. 11, 2006

(51) Int. Cl. H04B 15/00; H02B 1/00

(52) U.S. Cl. 381/123; 381/94.6

(57) ABSTRACT

An impedance selection circuit for the connection of multiple circuit braches is disclosed. The connection is supplied with the use of three switching jacks and connects directly to the branches through two jacks, or combines the branches in parallel or series to output to one jack. This circuit design comprises a low impedance jack 1, a middle impedance jack 2, and a high impedance jack 3. These jacks will connect to the multiple circuit branches individually, in series, or in parallel. In an example of using the impedance selection circuit, the user can implement the circuit to connect an amplifier to a multi-speaker array at three different impedances. The low impedance jack 1 yields a connection at a smallest fraction of the individual speakers' impedance. The middle impedance jack 2 yields a connection at a larger fraction such as one half the individual speakers' impedance. The high impedance jack 3 yields a connection at a higher impedance such as the same impedance as each individual speaker.

### TECHNICAL FIELD

This invention relates to impedance selection circuits, specifically to the impedance selection circuit of that connects multiple circuit branches together.

### BACKGROUND

In various applications, multiple circuit branches may need to be connected separately, or together in series or in parallel. For example, the signal between a guitar or other instrument amplifier and a speaker array is often manipulated to allow the speaker array to operate at three different impedances. The amplifier will typically have one four Ohm connection, one sixteen Ohm connection, and two eight Ohm connections. The impedance of the speaker array should match the amplifier connections used. A double pole double throw switch and two switching jacks are commonly used to change the impedance of the speaker array. This will allow a four speaker array of sixteen Ohm speakers to operate at four Ohm and sixteen Ohm in mono and eight Ohm stereo. The switch is used to switch between mono and stereo. Both switching phono jacks are used in stereo and only one switching jack in mono. This type of connection has been in use for many years.

There are two disadvantages to this type of impedance selection circuit. The first disadvantage is trying to determine which position the switch is in. Once the position is determined, the appropriate jack can then be plugged into. The second disadvantage is the cost of the double pole double throw switch. Of all the components used in the impedance selection circuit, the switch is the most expensive part.

### SUMMARY

Embodiments of an impedance selection circuit use stereo switching jacks to intuitively select the connection impedance for multiple branches of a circuit. A first jack is provided to allow a single connection of all the branches in parallel. A second jack is provided to allow a single connection of a subset of the branches in parallel. The first jack provides a single connection of the subset of branches, not connected to the second jack, in parallel when the first and second jacks are connected simultaneously. The third jack is provided to allow a single connection of the branches where a first subset of branches are connected in parallel and the remaining branches are connected in parallel and then connected to the first subset in series.

One embodiment is an electrical circuit that includes at least three interconnected switching jacks. The electrical circuit further includes at least two circuit branches interconnected to the at least three switching jacks. The at least two circuit branches are connected through the at least three switching jacks to yield a separate connection to at least one of the individual branches, a single connection of both branches in parallel, or a single connection of both branches in series depending upon the combination of plug connections to the three switching jacks.

Another embodiment is a method of controlling the impedance of a multi-branch electrical circuit that involves providing at least three interconnected switching jacks and at least two circuit branches interconnected to the at least three switching jacks. When plugging into only a first of the three interconnected switching jacks, a parallel connection of the at least two circuit branches is produced. When plugging into at least a second of the three interconnected switching jacks, a connection to one of the at least two circuit branches is produced. When plugging into only a third of the three interconnected switching jacks, a series connection of the at least two circuit branches is produced.

### DESCRIPTION OF THE DRAWINGS

FIG. 1A is a wiring schematic of the electrical connections between the speakers and the switching jacks with no plugs inserted according to one embodiment.

FIG. 1B is a wiring schematic of the electrical connections between the speakers and the switching jacks with a plug inserted into a first impedance jack to produce a parallel connection according to one embodiment.

FIG. 1C is a wiring schematic of the electrical connections between the speakers and the switching jacks with a plug inserted into a mid impedance jack to produce an individual connection to a single branch according to one embodiment.

FIG. 1D is a wiring schematic of the electrical connections between the speakers and the switching jacks with a plug inserted into the first impedance jack and the second impedance to produce individual connections to both branches according to one embodiment.

FIG. 1E is a wiring schematic of the electrical connections between the speakers and the switching jacks with a plug inserted into a third impedance jack to produce a series connection according to one embodiment.

FIG. 2 is a front view the three switching jacks attached to a circuit board of one embodiment.

FIG. 3 is a front view of the alternate embodiment of FIG. 2.

### DRAWINGS—REFERENCE NUMERALS

1 low impedance jack
2 middle impedance jack
3 high impedance jack
4 A speaker
5 B speaker
6 C speaker
7 D speaker
8 circuit board

### DETAILED DESCRIPTION

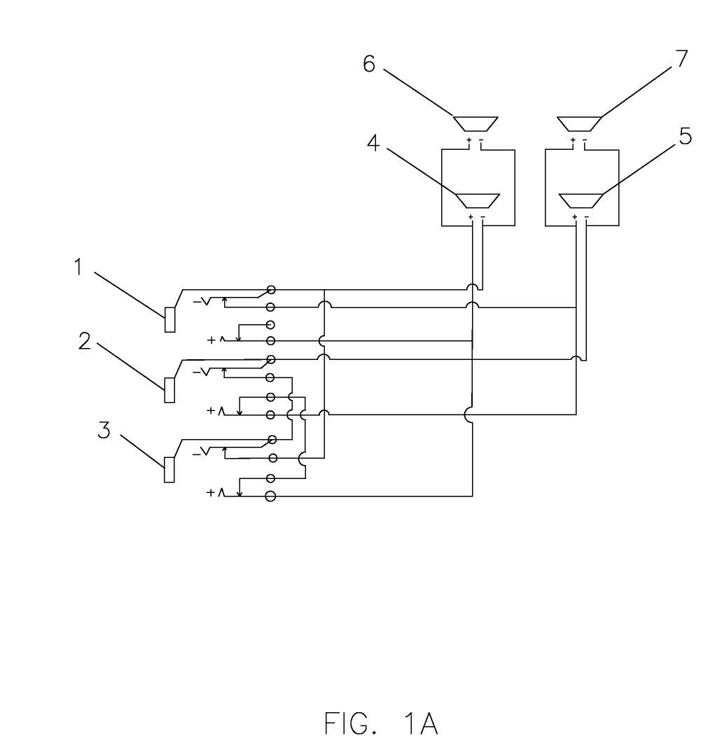

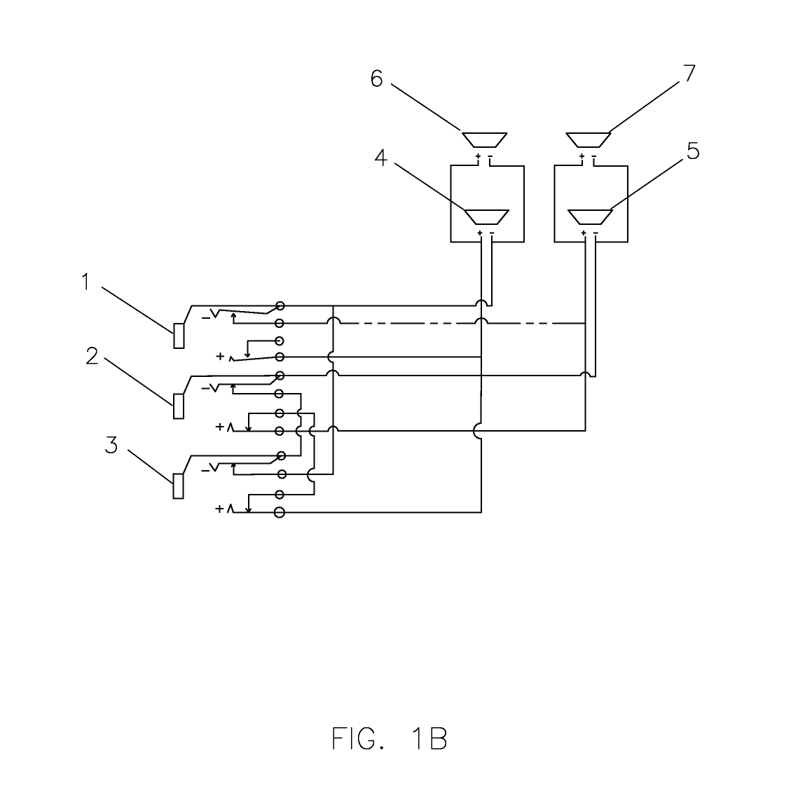

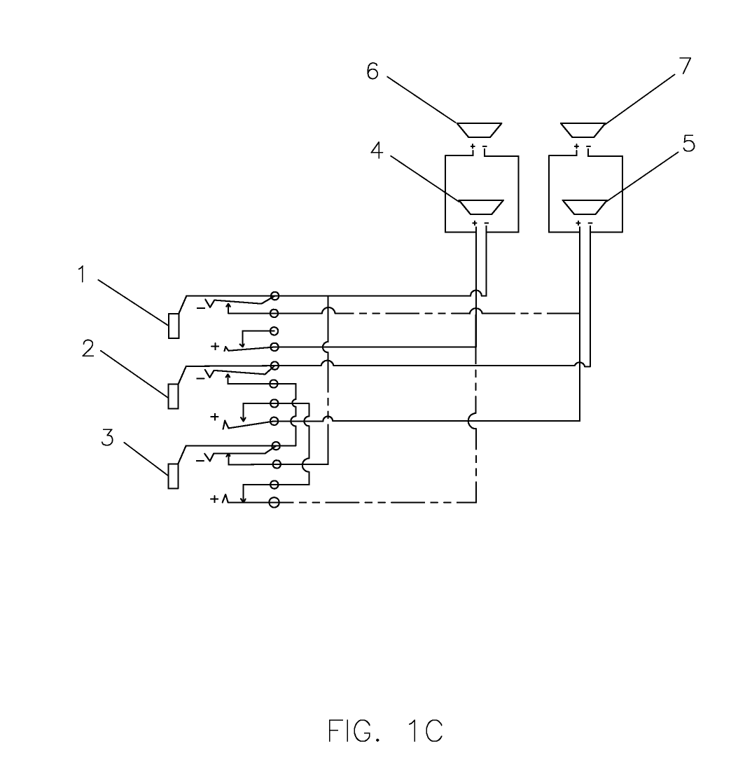

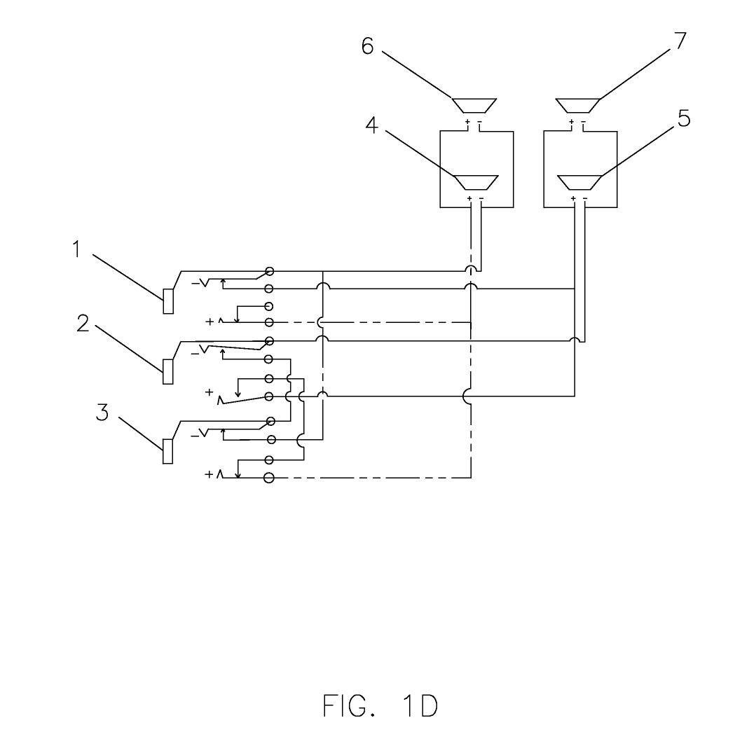

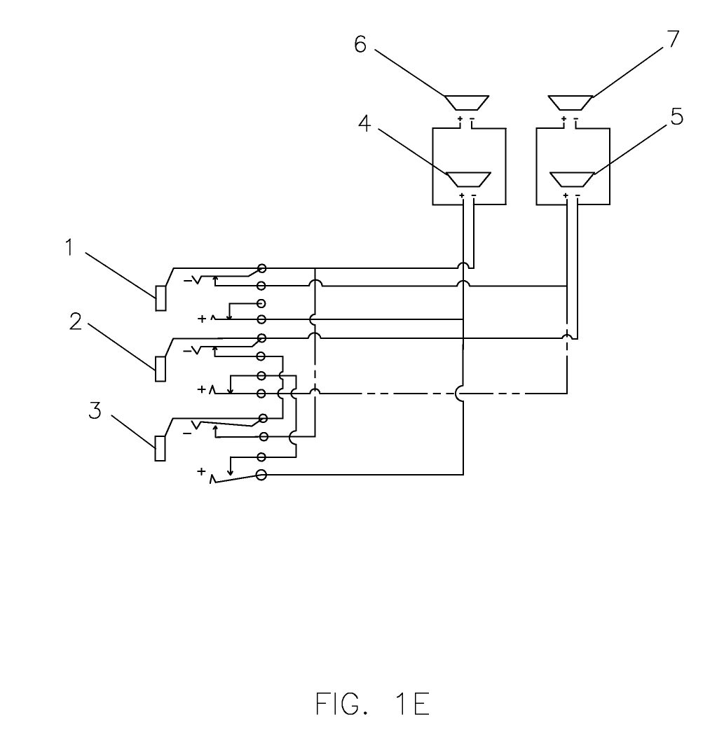

FIG. 1A is a wiring schematic of connections according to an exemplary embodiment between three stereo switching jacks and four speakers with no plugs inserted into the jacks. These examples are provided in relation to four speakers with two pairs of speakers serving as the multiple circuit branches but it will be appreciated that the impedance selection circuit is also applicable in other contexts and with other numbers of switching jacks and circuit branches.

A first jack, referred to herein as a low impedance jack 1, is shown with a connection between a positive tip of the low impedance jack 1 and a positive lead of an A speaker 4 and a positive tip of a third jack, referred to herein as a high impedance jack 3. A negative tip of the low impedance jack 1 is shown connected to a negative lead of the A speaker 4 and a negative switch tip of the high impedance jack 3. A negative switch tip of the low impedance jack 1 is shown connected to a positive lead of a B speaker 5 and a positive tip of a second jack, referred to herein as a middle impedance jack 2. A negative tip of the middle impedance jack 2 is connected to a negative lead of the B speaker 5. A positive switch tip of the middle impedance jack 2 is shown connected to a positive switch tip of the high impedance jack 3. A negative switch tip of the middle impedance jack 2 is shown connected to a negative tip of the high impedance jack 3. The positive lead of the A speaker 4 is shown connected to a positive lead of a C speaker 6. The negative lead of the A speaker 4 is shown connected to a negative lead of the C speaker 6. The positive lead of the B speaker 5 is shown connected to the positive lead of a D speaker 7. The negative lead of the B speaker 5 is shown connected to a negative lead of the D speaker 7. Each switching jack is of the type where the circuit is broken when a plug is inserted. In this particular example, all of the speakers the speakers are the same impedance for purposes if illustration, but it will appreciated that according to various embodiments, the impedance of each circuit branch may vary depending upon the application.

In operation one uses the circuit to control the impedance of a speaker array to match the impedance of the amplifier supplying the signal. With the impedance of all the speakers in the array the same, the low impedance jack 1 will give an impedance of one fourth the impedance of a single speaker and utilize all the speakers in the array. The middle impedance jack 1 will offer a connection of half the impedance of a single speaker and only connect to half the speakers in the array. With the middle impedance jack 2 in use, the low impedance jack 1 will connect to the other half the speakers in the array at half the impedance of a single speaker. The high impedance jack 3 will connect to all the speakers in the array at the same impedance of a single speaker.

FIG. 1B shows the result of a plug being inserted into only the low impedance jack 1. As can been seen, the state of the switching jacks results in several lines, shown in phantom, not being energized. The result is that both branches become connected in parallel relative to the low impedance jack 1. For 16 ohm speakers, the result is a single 4 ohm load.

FIG. 1C shows the result of a plug being inserted into only the middle impedance jack 1. As can been seen, the state of the switching jacks results in several lines, shown in phantom, not being energized. The result is that a single branch becomes connected to the middle impedance jack 2. For 16 ohm speakers, the result is a single 8 ohm load.

FIG. 1D shows the result of a plug being inserted into both the low impedance jack 1 and the middle impedance jack 2. As can been seen, the state of the switching jacks results in several lines, shown in phantom, not being energized. The result is that one branch becomes connected to the low impedance jack 1 while the other branch becomes connected to the middle impedance jack 1. For 16 ohm speakers, the result is two 8 ohm loads where each branch may be used for each channel of a stereo signal.

FIG. 1E shows the result of a plug being inserted into only the high impedance jack 3. As can been seen, the state of the switching jacks results in several lines, shown in phantom, not being energized. The result is that both branches become connected in series relative to the low impedance jack 3. For 16 ohm speakers, the result is a single 16 ohm load.

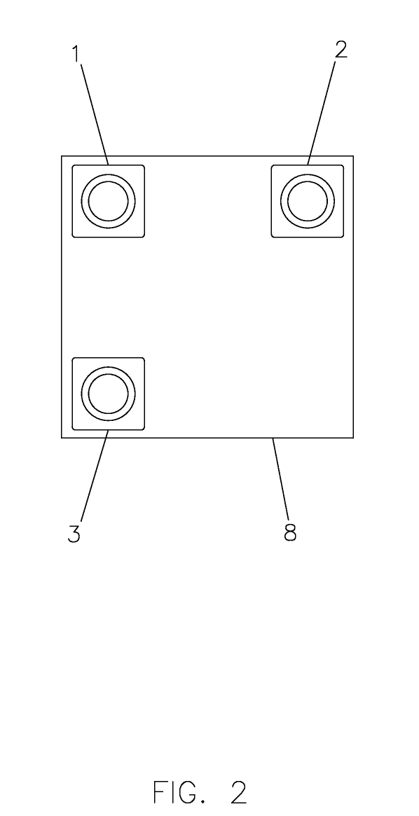

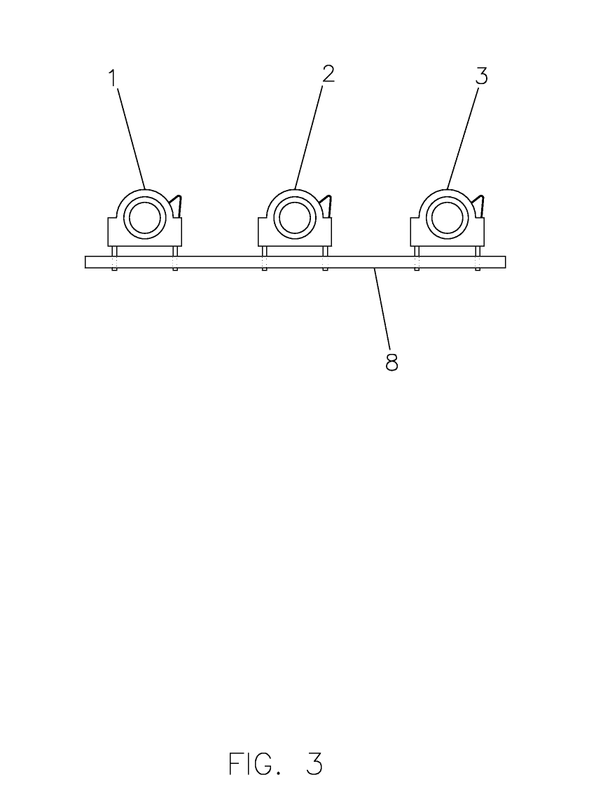

FIG. 2 shows one embodiment of an arrangement of the switching jacks on a circuit board 8. An additional embodiment of an arrangement of the switching jacks is shown in FIG. 3. This embodiment shows all the jacks inline with one another. This allows a bottom mounting jack at all locations.

There are many possibilities with regard to type of situations in which this circuit would be of use. The basic function of the circuit is to allow at least three scenarios of connections of at least two branches of a circuit. In scenario one, at least two branches of the circuit are combined in parallel and delivered to the low impedance jack. In scenario two, at least one branch is delivered to the middle impedance jack and at least one other branch of the circuit is available through the low impedance jack. In the third scenario, at least two branches of the circuit are combined in series and available through the high impedance jack.

Accordingly, it will be appreciated that the embodiments of an impedance selection circuit can be used to intuitively select the impedance of a speaker array or other circuit type, and can eliminate the double pole double throw switch. Although the description above contains much specificity, this description should not be construed as limiting the scope of the invention as defined by the claims but as merely providing illustrations of exemplary embodiments of this invention.

1. An electrical circuit, comprising:
at least three interconnected switching jacks; and
at least two circuit branches interconnected to the at least three switching jacks, wherein the at least two circuit branches are connected through the at least three switching jacks to yield a separate connection to at least one of the individual branches, a single connection of both branches in parallel, or a single connection of both branches in series depending upon the combination of plug connections to the three switching jacks.

2. The electrical circuit of claim 1, wherein a single connection of both branches in parallel occurs when a plug is positioned in only a first switching jack of the at least three interconnected switching jacks, wherein a separate connection to at least one of the individual circuit branches occurs when a plug is positioned in at least a second switching jack of the at least three interconnected switching jacks, and wherein a single connection of both branches in series occurs when a plug is positioned in only a third switching jack of the at least three interconnected switching jacks.

3. The electrical circuit of claim 1, wherein a first of the at least two circuit branches comprises at least one speaker.

4. The electrical circuit of claim 3, wherein a second of the at least two circuit branches comprises at least one speaker.

5. The electrical circuit of claim 1, wherein a first of the at least two circuit branches comprises at least two speakers.

6. The electrical circuit of claim 5, wherein the at least two speakers of the first of the at least two circuit branches are connected in parallel.

7. The electrical circuit of claim 5, wherein a second of the at least two circuit branches comprises at least two speakers.

8. The electrical circuit of claim 7, wherein the at least two speakers of the second of the at least two circuit branches are connected in parallel.

9. A method of controlling the impedance of a multi-branch electrical circuit, comprising:
providing at least three interconnected switching jacks and at least two circuit branches interconnected to the at least three switching jacks;
when plugging into only a first of the three interconnected switching jacks, producing a parallel connection of the at least two circuit branches;
when plugging into at least a second of the three interconnected switching jacks, producing a connection to one of the at least two circuit branches; and
when plugging into only a third of the three interconnected switching jacks, producing a series connection of the at least two circuit branches.

10. The method of claim 9, wherein when plugging into the first and the second of the three interconnected switching jacks, producing a separate connection to each of the at least two circuit branches.

11. The method of claim 9, wherein providing at least two circuit branches comprises providing a first speaker of a first circuit branch and a second speaker of a second circuit branch.

12. The method of claim 11, wherein providing at least two circuit branches further comprises providing a third speaker in parallel to the first speaker in the first circuit branch and providing a fourth speaker in parallel to the second speaker in the second circuit branch.
